(19) United States
(12) Patent Application Publication
(10) Pub. No.: US 2020/0090893 A1
(43) Pub. Date: Mar. 19, 2020

(54) FUSE

(71) Applicant: GROUP TALENTS LIMITED, Tsuen Wan, NT Hong Kong (CN)

(72) Inventor: Koon Yui LEUNG, Tsuen Wan, NT Hong Kong (CN)

(21) Appl. No.: 16/473,164

(22) PCT Filed: Dec. 20, 2017
(86) PCT No.: PCT/IB2017/058183

§ 371 Date: Jun. 24, 2019

(30) Foreign Application Priority Data
Dec. 22, 2016 (CN) 201621417122.1

(51) Int. Cl. H01H 85/143; H01H 85/50

(52) U.S. Cl. CPC H01H 85/143; H01H 85/1755; H01H 85/50

(57) ABSTRACT

A kind of fuse, comprising, outer cartridge body with both open ends, inner cartridge body with both open ends and provided inside the said outer cartridge body, fuse core provided inside the said inner cartridge body, left and right inner copper bushes provided at and covering both ends of the said outer cartridge body, left and right outer copper bushes provided at and covering the said inner copper bushes and both ends of the said outer cartridge body; Wherein, one end of the said inner copper bush is the first open end, and the other end is the first closed end, the end face of the said first closed end has the first opening; preferably, the said first open end and the said outer cartridge body form interference fit connect through punching. End of the said fuse core extends and passes through the said first opening, and is preferably fixed to the end face of the said first closed end through spot welding. One end of the said outer copper bush is the open end, the other end is the closed end. Preferably, through pressing, the open end of the said outer copper bush and the said first closed end and/or the said outer cartridge body form interference fit joint.

### TECHNICAL FIELD

The utility model relates to a kind of fuse, specifically relates to a kind of cartridge fuse (preferably double-cartridge fuse).

### BACKGROUND OF THIS UTILITY MODEL

Fuse (fuse link) is a component which is connected to an electrical circuit for protection purpose. If there is over-current happening in the circuit, the metal wire or sheet metal within a fuse is melted at a high temperature which causing an open circuit to interrupt the current flow to protect the circuit from damage.

As for the fuses in market, there are mainly two types: single cartridge (ceramic cartridge) is provided with the inner and outer copper bushes, and the fuse wire is affixed by the inner and outer copper bushes; or single cartridge (melamine fiber cartridge) is provided with single copper bush, and the fuse wire is affixed with tin soldering .

In addition, there is also double-cartridge fuse. Presently, the double-cartridge design is mainly applied to fuse (fuse link) with pretty high rated current and voltage. The main body of such fuse is glass fiber coated with resin/melamine cartridge. Such cartridge has good electrical performance and strong arcing absorption performance, which is good for breaking capacity requirement for the fuse (fuse link). However, the cost of such cartridge is high, and its surface is not so smooth and pad printing cannot be directly conducted on such cartridge.

### SUMMARY OF THIS UTILITY MODEL

A kind of fuse is disclosed, comprising, outer cartridge body with both open ends, inner cartridge body with both open ends and provided inside the said outer cartridge body, a fuse core provided inside the said inner cartridge body, left and right inner copper bushes provided at and covering both ends of the said outer cartridge body, left and right outer copper bushes provided at and covering the said inner copper bushes and both ends of the said outer cartridge body;

Wherein, one end of the said inner copper bush is the first open end, and the other end is the first closed end, the end face of the said first closed end has the first opening; preferably, the said first open end and the said outer cartridge body form interference fit connect through punching.

The end of the said fuse core extends and passes through the said first opening, and is preferably fixed to the end face of the said first closed end through spot welding.

The one end of the said outer copper bush is the open end, and the other end is the closed end. Preferably, the open end of the said outer copper bush and the said first closed end and/or the said outer cartridge body form interference fit connect through punching.

In some embodiments, further comprising, there are also left and right pin copper bushes provided at and covering the said outer copper bushes and both ends of the said outer cartridge body; one end of said pin copper bush is the second open end, the other end is the second closed end. Preferably, the end face of the said second closed end forms the opening part and pin part through punching. The said pin part is configured to bend by 180 degrees toward the external side of end face of the said second closed end and to form the pin or plug-in piece extending along the radial direction of the said pin copper bush; preferably, the second open end and the closed end of the said outer copper bush and/or the said outer cartridge body form the interference fit connect through punching.

In some embodiments, the said pin part presents as T-shape. The said pin part is configured to bend by 180 degrees toward the external side of end face of the said second closed end so that the long part of the T-shape pin part forms the pin or plug-in piece extending along the radial direction of the said pin copper bush. The extending direction of the said pin or plug-in piece and the axial direction of the said fuse are in orthogonal direction.

In some other embodiments, there is also blocking component provided between the said outer copper bushes and said inner copper bushes and preferably covering the spot welded part of the end face of the said first closed end. The said blocking component is made of insulating material and is configured to improve the current and/or arc blocking capacity of the said fuse.

In some embodiments, the outside surface of the said outer cartridge body has the printed labeling part.

In some embodiments, the said outer cartridge body and inner cartridge body are made of different materials respectively, and they are closely sheathed to prevent loosening. Wherein, the said outer cartridge body is made of the material resisting high temperature, and the said inner cartridge body is made of light and conveniently produced material; the said outer cartridge body and inner cartridge body are configured to improve the electrical performance of the said fuse and reduce the gross cost of the fuse requiring high electrical performance.

In some embodiments, the said outer cartridge body is made of ceramic or glass, and the said inner cartridge body is made of glass fiber, polyester, resin, glass fiber resin and/or melamine. The inner diameter and outer diameter of the said outer cartridge body and inner cartridge body are designed to make the said outer cartridge body and inner cartridge body to conveniently and closely sheath; and/or adhesive substance or adhesive agent is provided between the said outer cartridge body and inner cartridge body to reach the fixing and/or close fitting.

In some embodiments, the shapes of the said first opening include the semicircle shape, triangular shape, rectangular shape, polygonal shape and/or combination of such shapes.

In some embodiments, the said fuse core presents the linear shape or sheet shape; and/or the said fuse core presents the sheet shape with several mutually separated holes.

In some embodiments, the said fuse core extends along axial direction of the said inner cartridge body; and/or the axis of the said fuse core coincides with or parallels to the axis of the said inner cartridge body.

### DESCRIPTION OF ATTACHED DRAWINGS

In the following, with referring to the attached drawings and embodiments, the technical solution of present disclosure will be described. The attached drawings include:

FIG. 1 is a schematic illustration of the embodiment fuse of present disclosure;

FIG. 2 is an exploded drawing of the embodiment fuse in FIG. 1 ;

FIG. 3 is the schematic illustration of the embodiment inner copper bush of the embodiment fuse of present disclosure; and

FIGS. 4a-4b are schematic illustrations of embodiment pin copper bushes with various shapes of the embodiment fuse of present disclosure.

### EMBODIMENT

In the following, some preferred embodiments of present disclosure are given through combining the attached drawings in order to provide detailed description of the technical solution.

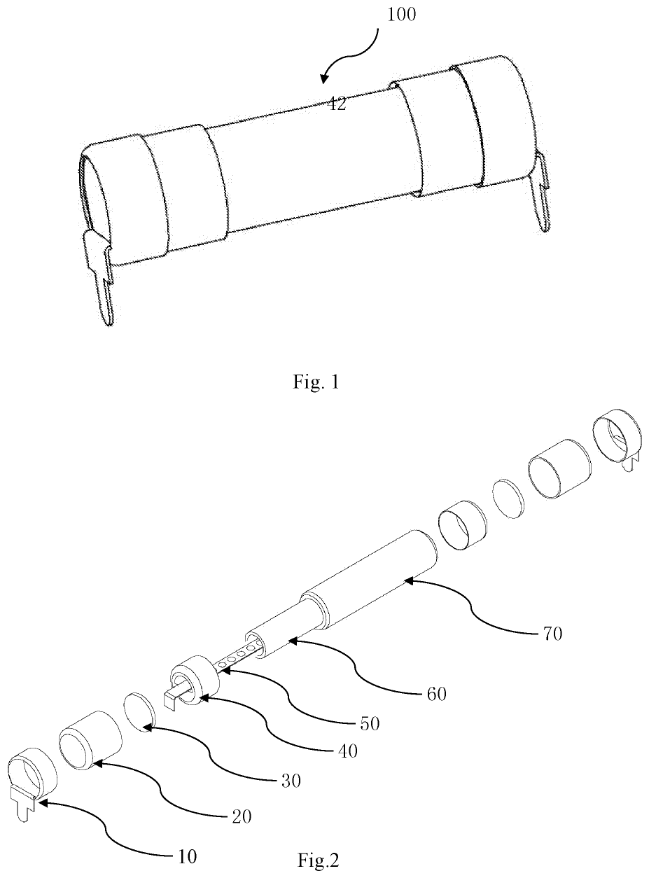

Referring to FIGS. 1-2, the schematic illustration and exploded drawing of the embodiment fuse 100 of present disclosure are shown as respectively. Shown as the figures, the embodiment fuse 100 is a double-cartridge fuse 100, consists of outer cartridge body 70 with both open ends, inner cartridge body 60 with both open ends and provided inside the said outer cartridge body 70, fuse core 50 provided inside the said inner cartridge body 60, left and right inner copper bushes 40 provided at and covering both ends of the said outer cartridge body 70, left and right outer copper bushes 20 provided at and covering the said inner copper bushes 40 and both ends of the said outer cartridge body 70;

In some embodiments, the fuse 100 is a single-cartridge fuse, namely consists of the outer cartridge body 70 only. The other structure is generally identical to those shown in FIGS. 1-2.

In some embodiments, the outer surface of the said outer cartridge body 70 has the part for printing marked performance and parameters.

In some embodiments, the said fuse core 50 presents in form of a wire or sheet shape. Preferably, the said fuse core presents the sheet shape with several mutually separated holes, just shown as FIG. 2.

In some embodiments, the said fuse core extends along axial direction of the said inner cartridge body; and/or the axis of the said fuse core coincides with or parallels to the axis of the said inner cartridge body, just shown as FIG. 2.

According to present disclosure, one end of the said inner copper bush 40 is the first open end adjoining the outer cartridge body, the other end is the first closed end distant from the outer cartridge body. The end face of the said first closed end has the first opening; preferably, the said first open end and the said outer cartridge body form interference fit connect.

Compared with existing technology that the inner copper bush has both open ends and has the same diameter, the inner copper bush in present disclosure has fairly much copper material. In this way, it can assist the fuse (fuse link) to reduce the internal resistance, maintain fine electrical contact and reduce temperature rise when the fuse (fuse link) is energized.

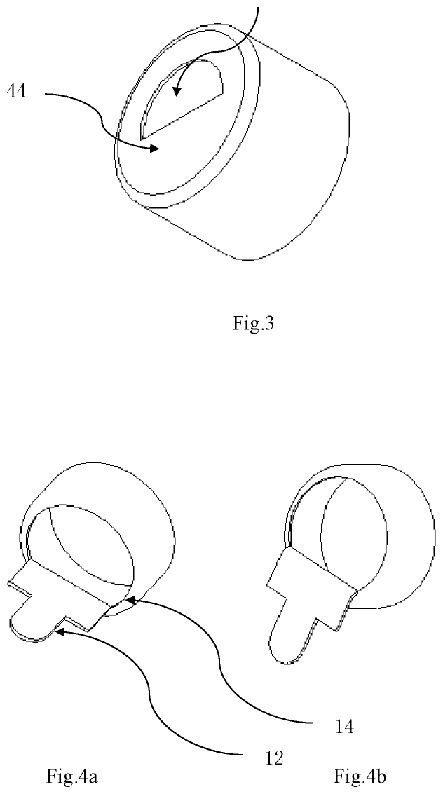

In some embodiments, the shapes of the said first opening include the semicircle shape, triangular shape, rectangular shape, polygonal shape and/or combination of such shapes. Shown as FIG. 3, there is the semi-circle shape first opening 42 at the end face 44 of the first closed end. In some embodiments, the end of the fuse core 50 in present disclosure extends and passes through the first opening 42, is preferably fixed to the end face 44 of the first closed end through spot welding.

Compared with the fuse utilizing the current technology that the fuse core/fuse wire is generally fixed through welding the ring edge/end side of the inner copper bush with tin wire, end face 44 in present disclosure provides a supporting face, and thus the fuse core 50 can be fixed through spot welding and the tin soldering method is not required. In this way, the temperature rise of fuse (fuse link) caused by external heating can be reduced, and effect on the electrical conductivity is reduced.

Shown as the figures, one end of the said outer copper bush 20 is the open end, the other end is the closed end. Preferably, the open end of the said outer copper bush 20 and the said first closed end and/or the said outer cartridge body form interference fit connect through punching. In operation, the said outer copper bush 20 of the said fuse is connected to the circuit board via the known clamping component, or can be plugged into the special socket of the circuit board to protect the circuit from damage caused by the over-current.

In some embodiments, the fuse 100 also consists of the left and right pin copper bushes 10 provided at and covering the said outer copper bushes and both ends of the said outer cartridge body.

Shown as FIGS. 4a-4b, one end of said pin copper bush 10 is the second open end, the other end is the second closed end. Preferably, the end face 14 of the said second closed end forms the opening part and pin part 12 through punching. The said pin part is configured to bend by 180 degrees toward the external side of end face 14 of the said second closed end and to form the pin or plug-in piece extending along the radial direction of the said pin copper bush; preferably, through pressing, the second open end and the closed end of the said outer copper bush 20 and/or the said outer cartridge body form the interference fit connect.

Shown as the figure, the said pin part preferably is T-shape pin part 12. The said pin part 12 is configured to bend by 180 degrees toward the external side of end face 14 of the said second closed end so that the long part of the T-shape pin part forms the pin or plug-in piece extending along the radial direction of the said pin copper bush. The extending direction of the said pin or plug-in piece and the axial direction of the said fuse are orthogonal and mutually perpendicular.

Shown as the figures, the pin copper bushes are mounted to both ends of the fuse (fuse link) so that the fuse can be mounted or fixed to PCB for use. The pin copper bush is mechanically fixed, soldering tin is not required in order to reduce temperature rise of the fuse (fuse link) passing the tin oven (in case of solder-reflow/wave-front soldering) and reduce effect caused by externally heating fuse (fuse link) on the electrical conductivity of the fuse core; the fuse (fuse link) can be integrated with the pin copper bush in formation so that the fuse (fuse link) can be conveniently and directly welded to PCB. The pin copper bush in present disclosure makes the user to difficultly or impossibly remove the pin copper bush from the fuse (fuse link), which is different from application of copper clamp for the fuse wire of the existing technology. In other words, if it needs to replace the fuse (fuse link), the entire fuse (fuse link) and the pin copper bush must be removed from PCB together. This requires the experienced technical person to replace the fuse (fuse link) with the relevant apparatuses, safety of the ordinary and non-technical person is guaranteed and safety of the end user can also be guaranteed.

In addition, the shape design of such pin copper bush of fuse wire (fuse) can save material. The pin part 12 itself is formed through inverse bending toward the external side from the end face or bottom of the pin copper bush, and the material at the end face or the plain surface portion of the pin copper bush is fully used.

In some embodiments, the fuse 100 also consists of blocking component 30 provided between the said outer copper bushes 20 and said inner copper bushes 40 and preferably covering the spot welded part of the end face of the said first closed end. The said blocking component 30 is made of insulating material and is configured to improve the current and/or arc blocking capacity of the said fuse. Shown as FIG. 2, the blocking component 30 can be formed to be circle shape; in other embodiments, the blocking piece 30 can be formed to be the semicircle shape, triangular shape, rectangular shape, polygonal shape and/or combination of such shapes.

In some embodiments, the said outer cartridge body and inner cartridge body are made of two different materials respectively, and they are closely sheathed to prevent loosening. Wherein, the said outer cartridge body is made of the material resisting high temperature, and the said inner cartridge body is made of light and conveniently produced material, vice versa (depending on the specific application); the said outer cartridge body and inner cartridge body are configured to improve the electrical performance of the said fuse and reduce the gross cost of the fuse requiring high electrical performance.

In some embodiments, the said outer cartridge body is preferably made of ceramic or glass, and the said inner cartridge body is preferably made of glass fiber, polyester, resin, glass fiber resin and/or melamine. In some other specific embodiments, the said inner cartridge body is preferably made of ceramic or glass, and the said outer cartridge body is preferably made of glass fiber, polyester, resin, glass fiber resin and/or melamine. The inner diameter and outer diameter of the said outer cartridge body and inner cartridge body are designed to make the said outer cartridge body and inner cartridge body to conveniently and closely sheath; and/or adhesive substance or adhesive agent is provided between the said outer cartridge body and inner cartridge body to reach the fixing and/or close connect.

With application of the double-cartridge fuse in present disclosure, the breaking capacity of the fuse (fuse link) can be greatly higher than that of the single cartridge fuse; secondly, the material cost can be reduced; in addition, the performance labeling problem of the fuse (fuse link) can be solved, it does not need to use the paper label that are easier to fall off and damaged.

The characteristics under the attached claims (jointly and separately in proper place) form a part of present disclosure, and are introduced herein for reference.

Although different examples or embodiments have been described in present disclosure, it is understood that such examples or embodiments are used for description purpose instead of limiting the protection scope. For example, as for the example application provided under present disclosure, such constructions as the pin copper bush, inner and outer copper bushes and so on are respectively displayed as or configured to be ring shape/round shape. However, on the premise that the generality is not lost, the other shapes and structures according to the essential information of present disclosure can also be utilized. It is understood that the parts or components of different example embodiments can be mutually combined and/or assembled in mixture under proper conditions to form the other variants without losing the generality.

1. A kind of fuse, comprising, outer cartridge body with both open ends, inner cartridge body with both open ends and provided inside the said outer cartridge body, fuse core provided inside the said inner cartridge body, left and right inner copper bushes provided at and covering both ends of the said outer cartridge body, left and right outer copper bushes provided at and covering the said inner copper bushes and both ends of the said outer cartridge body;
wherein, one end of the said inner copper bush is the first open end, and the other end is the first closed end, the end face of the said first closed end has the first opening; preferably, the said first open end and the said outer cartridge body form interference fit connect through punching;
end of the said fuse core extends and passes through the said first opening, and is preferably fixed to the end face of the said first closed end through spot welding;
one end of the said outer copper bush is the open end, the other end is the closed end. Preferably, through pressing, the open end of the said outer copper bush and the said first closed end and/or the said outer cartridge body form interference fit connect.

2. The fuse of claim 1, wherein, there are also left and right pin copper bushes provided at and covering the said outer copper bushes and both ends of the said outer cartridge body;
one end of said pin copper bush is the second open end, the other end is the second closed end;
preferably, the end face of the said second closed end forms the opening part and pin part through punching; the said pin part is configured to bend by 180 degrees toward the external side of end face of the said second closed end and to form the pin or plug-in piece extending along the radial direction of the said pin copper bush; preferably, through punching, the second open end and the closed end of the said outer copper bush and/or the said outer cartridge body form the interference fit connect.

3. The fuse of claim 2, wherein, the said pin part presents T-shape; the said pin part is configured to bend by 180 degrees toward the external side of end face of the said second closed end so that the long part of the T-shape pin part forms the pin or plug-in piece extending along the radial direction of the said pin copper bush; the extending direction of the said pin or plug-in piece and the axial direction of the said fuse are orthogonal.

4. The fuse of claim 1, wherein, there is also blocking component provided between the said outer copper bushes and said inner copper bushes and preferably covering the spot welded part of the end face of the said first closed end; the said blocking component is made of insulating material and is configured to improve the current and/or arc blocking capacity of the said fuse.

5. The fuse of claim 1, wherein, the outer surface of the said outer cartridge body has the printed labeling part.

6. The fuse of claim 1, wherein, the shapes of the said first opening include the semicircle shape, triangular shape, rectangular shape, polygonal shape and/or combination of such shapes.

7. The fuse of claim 1, wherein, the said fuse core presents the linear shape or sheet shape; and/or the said fuse core presents the sheet shape with several mutually separated holes.

8. The fuse of claim 1, wherein, the said fuse core extends along axial direction of the said inner cartridge body; and/or the axis of the said fuse core coincides with or parallels to the axis of the said inner cartridge body.

9. The fuse of claim 1, wherein, the said outer cartridge body and inner cartridge body are made of different materials respectively, and they are closely connect to prevent loosening; wherein, the said outer cartridge body is made of the material resisting high temperature, and the said inner cartridge body is made of light and conveniently produced material; the said outer cartridge body and inner cartridge body are configured to improve the electrical performance of the said fuse and reduce the gross cost of the fuse requiring high electrical performance.

10. The fuse of claim 1, wherein, the said outer cartridge body is made of ceramic or glass, and the said inner cartridge body is made of glass fiber, polyester, resin, glass fiber resin and/or melamine; the inner diameter and outer diameter of the said outer cartridge body and inner cartridge body are designed to make the said outer cartridge body and inner cartridge body to conveniently and closely sheath; and/or adhesive substance or adhesive agent is provided between the said outer cartridge body and inner cartridge body to reach the fixing and/or close connect.
